(19) United States
(12) Patent Application Publication
(10) Pub. No.: US 2004/0225817 A1
(43) Pub. Date: Nov. 11, 2004

(54) Mechanism for effecting a fast data transmission between communication devices

(75) Inventor: Shun-Ping Wang, Taipei Hsieng (TW)

Correspondence Address: BACON & THOMAS, PLLC, 625 SLATERS LANE, FOURTH FLOOR, ALEXANDRIA, VA, 22314

(73) Assignee: Inventec Appliances Corp., Hsieng (TW)

(21) Appl. No.: 09/912,296

(22) Filed: Jul. 26, 2001

(51) Int. Cl. G06F 13/38; G06F 13/40

(52) U.S. Cl. 710/305

(57) ABSTRACT

A fast data transmission mechanism comprises a data transmission software in a memory of each of communication devices and a data transmission interface in each device respectively for establishing a connection between the devices through at least one signal line and effecting a data transmission therebetween wherein in transmitting data from one device to the other remote one, the data transmission software divides data into a plurality of units each having a predetermined size, the units are individually transmitted to the other device through the signal line, and the other device transmits the units through a wireless communication; and in receiving data, the data transmission software in the device receives the units sent from the remote other device, the received units are sent to one of the devices through the signal line, and the data transmission software in the device regroups the units to recover as an original data.

### FIELD OF THE INVENTION

The present invention relates to communication devices and more particularly to a mechanism for effecting a fast data transmission between communication devices.

### BACKGROUND OF THE INVENTION

In recent years, the unit price of cellular phones has been reduced significantly as the communication industry has boomed. And in turn more and more people like to use cellular phones. Further, as development revolved more advantageous benefits are provided by mobile phones, which have become ever more slim, multifunctional, and convenient while still maintaining a high communication quality. Moreover, there is a communication software provided by a newly commercial mobile phone for providing a variety of data transmissions such as alphabetic data, graphical data, or the like. Hence, in additional to conversation it is possible to communicate alphabetic data, graphical data, etc. between two mobile phone users. This greatly enhances the convenience of communication among people.

A conventional data transmission implemented by mobile phones is shown in FIG. 1 wherein data is transmitted from one mobile phone to a specific remote mobile phone or a plurality of remote mobile phones through a telephone exchange. However, in either of the above cases, the data transmission rate is at most 14K bit per second (bps) as defined by the existing mobile phone communication protocol. Hence, a lot of time is consumed in transmitting a large amount of data. This is inconvenient in use. Thus, a need for improvement exists.

### SUMMARY OF THE INVENTION

It is therefore an object of the present invention to provide a mechanism comprising a data transmission software in a memory of each of a plurality of communication devices and a data transmission interface in each device respectively for establishing a connection between the devices through at least one signal line and effecting a data transmission therebetween wherein in transmitting data from one local device to a remote one, the data transmission software divides data into a plurality of units each having a predetermined size, the units are individually transmitted to another local device through the signal line, and the other local device transmits the units through a wireless communication with a corresponding remote device; and in receiving data, the data transmission software in the device receives the units sent from the remote other device, the received units are sent to one of the local devices through the signal line, and the data transmission software in the device regroups the units to recover as an original data. By utilizing this, it is possible of effecting a fast data transmission between communication devices.

The above and other objects, features and advantages of the present invention will become apparent from the following detailed description taken with the accompanying drawings.

### BRIEF DESCRIPTION OF THE DRAWINGS

FIG. 1 schematically shows a conventional data transmission implemented by mobile phones;

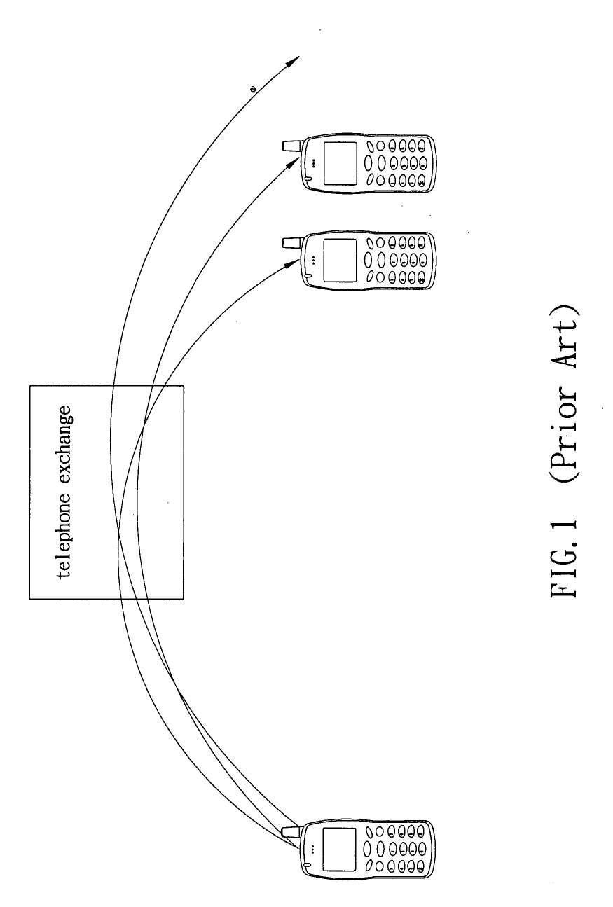

FIG. 2 schematically shows a fast data transmission implemented by communication devices according to the invention;

FIG. 3 is a flow chart diagram showing how CPU of a communication device transmits data; and

FIG. 4 is a flow chart diagram showing how CPU of the other communication device receives data.

### DETAILED DESCRIPTION OF THE PREFERRED EMBODIMENTS

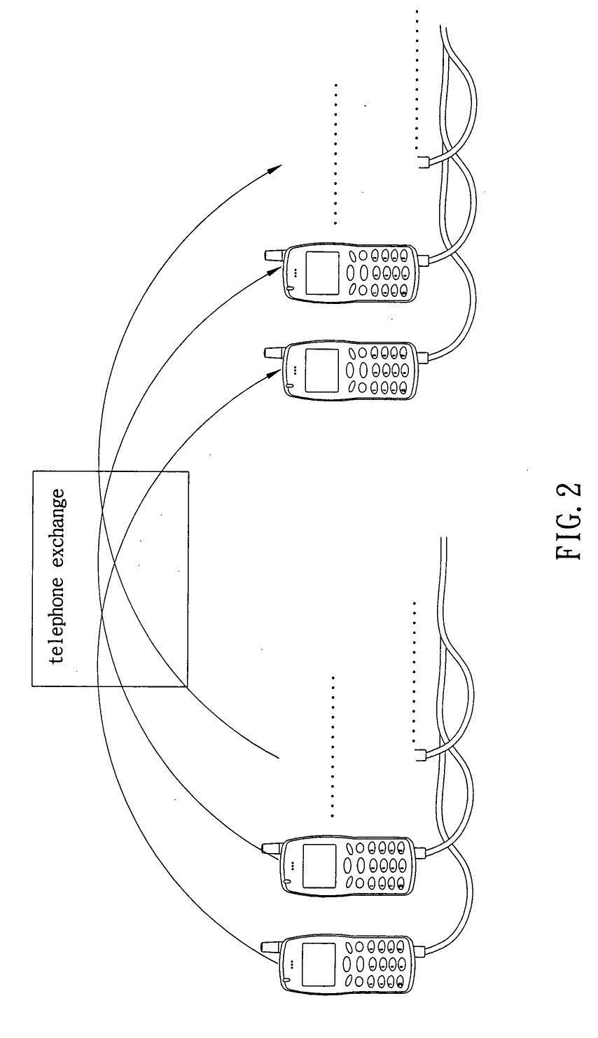

Referring to FIG. 2, there is shown a mechanism for effecting a fast data transmission between communication devices constructed in accordance with the invention. A data transmission interface is provided in each communication device. A data transmission software is installed in the memory of each communication device. With such interface, one communication device, referred to for convenience as a “local” communication device, may establish a connection with another communication device, referred to as another “local” communication device, having the same configuration through at least one signal line. Thus, communication devices may effect a signal transmission therebetween.

In the case of transmitting data from one local communication device to another remote one, the user may input instructions provided by the data transmission software by keying on one communication device to set the one communication device as a master and another local communication device as a slave. Then the data transmission software divides the data into a plurality of units each having a predetermined size. Such units are individually transmitted to the slave through the local signal line. Finally, all channels belonging to master and slave are utilized for transmitting units through wireless communication to the remote communication device.

In another case the master and slave may utilize data transmission software to receive units from a remote communication device. Then units are sent to one master over the signal line. Data transmission software in the communication device may then regroup units to recover a complete original data. Note that methods for dividing data and regrouping data units are well known. Further, the object of the invention is not to provide a method to solve problems associated therewith. Thus a detailed description thereof is omitted herein for the sake of brevity.

In the invention, the data transmission interface is a universal serial bus (USB) interface. Each communication device may utilize a transmission protocol implemented in USB to determine how to transmit a signal. In detail, in response to data divided into units by the master, the transmission protocol implemented in USB is utilized to transmit units to a remote communication device through an appropriate slave. As the remote communication device receives units, the transmission protocol is again utilized to send the received units to the master for regrouping.

In the invention, when data is divided into a plurality of units by the master, a unique identification (ID) associated with one communication device (master or slave) is assigned to each unit. Hence, the master may send a unit to a corresponding slave based on the ID. Moreover, as the communication device receives units and the received units are sent to the master for regrouping, data transmission software in the master may assemble units to recover a complete original data based on the IDs.

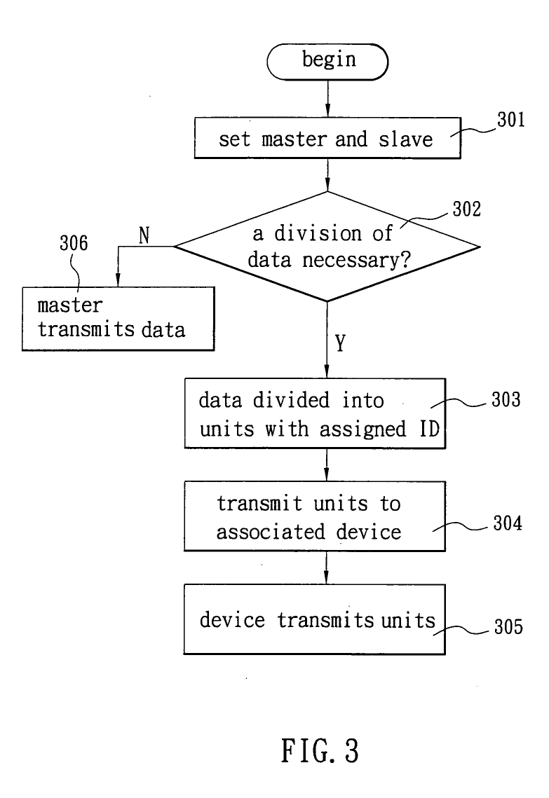

Referring to FIG. 3, a flow chart diagram shows how a central processing unit (CPU) of a communication device transmits a record of data. In step 301, the user may input instructions provided by the data transmission software by keying on one communication device to set the one communication device as a master and another communication device connected to the one communication device by a signal line as a slave. In step 302, data transmission software in the master determines whether a division of data is necessary. If yes, the process goes to step 303. If not, the process goes to step 306 for the causing master to transmit data prior to ending the process. In step 303, the data is divided into a plurality of units and a unique identification (ID) associated with one communication device is assigned to each unit. In step 304, units are transmitted to a communication device through signal line. In step 305, the communication device transmits units.

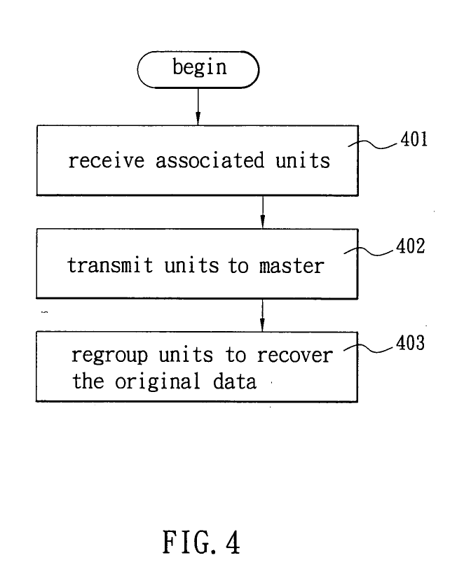

FIG. 4 is a flow chart diagram showing how the CPU of the other communication device receives data. In step 401, the associated units are received as determined by the data transmission software. In step 402, units are transmitted to a communication device set as a master through a signal line. In step 403, data transmission software in the master is utilized again to regroup units to recover the original record of data.

In the invention, the communication device is implemented as a mobile phone. Also, data transmitted on the mobile phone is divided into a plurality of units each having a predetermined size which is no more than 14K bit per second (bps) as defined by the existing mobile phone communication protocol. In one example, a record of data having a size of 100K bit per second (bps) is divided into eight units each of 12.5K bit per second (bps). Hence, it is possible to transmit such data in one second if there are eight mobile phones are coupled together. Hence, the invention can significantly save data transmission time.

While the invention has been described by means of specific embodiments, numerous modifications and variations could be made thereto by those skilled in the art without departing from the scope and spirit of the invention set forth in the claims.

1. A mechanism comprising a data transmission software in a memory of each of a plurality of local communication devices, and a data transmission interface in each device for respectively establishing a connection between said local devices through at least one local signal line, and effecting a data transmission between the plurality of local communication devices via the local signal line,
wherein in wirelessly transmitting data from one of the local devices to at least one remote device, said data transmission software divides the data into a plurality of units each having a predetermined size, a portion of said units being individually transmitted to another of said local devices through said local signal line, and said one of the local devices and said another local device transmitting said units through a wireless communication; and
wherein in receiving data, said data transmission software in said one of said local devices and said another of said local devices receives said units sent from said at least one remote device, at least a portion of said received units being sent from said another of said local devices to said one of said local devices through said local signal line, and said data transmission software in said one of said local devices regrouping said units to recover original transmitted data.

2. The mechanism of claim 1, wherein in transmitting data from said one local device to said one remote device, input instructions provided by said data transmission software set said one local device as a master and said another local device as a slave, and wherein said data transmission software divides data into a plurality of units each having a predetermined size, individually transmits said units to said slave through said local signal line, and utilizing all channels belonging to said master and said slave for transmitting said units through said wireless communication.

3. The mechanism of claim 1, wherein said data transmission interface is a universal serial bus (USB) interface.

4. The mechanism of claim 2, wherein when said data is divided into a plurality of units by said master a unique identification (ID) associated with one device is assigned to each unit, said master sends each unit to said corresponding slave based on said ID, said units received by said device are sent to said master for regrouping, and said data transmission software in said master assembles said units to recover said original data.

5. The mechanism of claim 1, wherein said one local device comprises a central processing unit (CPU) capable of transmitting a record of data by performing the steps of:
(a) inputting instructions provided by said data transmission software by keying on one device to set one device as a master and said other device as a slave;
(b) determining whether a division of data is necessary by said data transmission software in said master;
(c) if a division of data is necessary, dividing said data into a plurality of units and assigning a unique identification (ID) associated with said another local device to each unit;
(d) transmitting said units to said another local device through said local signal line; and
(e) transmitting said units by said another local device.

6. The mechanism of claim 5 wherein if a result in step (b) is negative, causing said master to transmit data.

7. The mechanism of claim 5, wherein said CPU is capable of receiving said record of data by performing the steps of:
(f) receiving said associated units as determined by said data transmission software;
(g) transmitting said units to said device set as said master through said local signal line; and
(h) regrouping said units by said data transmission software in said master to recover said original data.

8. The mechanism of claim 1, wherein said device is a mobile phone and data transmitted on said mobile phone is divided into a plurality of units each having a predetermined size which is no more than a maximum size defined by an existing mobile phone communication protocol.
